(19) United States
(12) Patent Application Publication
(10) Pub. No.: US 2016/0347922 A1
(43) Pub. Date: Dec. 1, 2016

(54) EXTRUDED POLYSTYRENE FOAM

(71) Applicant: Owens Corning Intellectual Capital, LLC, Toledo, OH (US)

(72) Inventors: Xiangmin Han, Stow, OH (US); Yadollah Delaviz, Lewis Center, OH (US); Chase J. Boudreaux, Canton, OH (US); Mitchell Zane Weekley, Tallmadge, OH (US); Christine Turner, Barberton, OH (US)

(21) Appl. No.: 15/163,934

(22) Filed: May 25, 2016

Related U.S. Application Data
(60) Provisional application No. 62/167,949, filed on May 29, 2015.

(51) Int. Cl. C08J 9/12; C08J 9/00

(52) U.S. Cl. CPC C08J 9/122; C08J 9/009; C08J 9/0061; C08J 2325/06; C08J 2201/03; C08J 2203/06; C08J 2205/052; C08J 2433/20

(57) ABSTRACT

A composition for and method of making extruded polystyrene (XPS) foam is provided. The composition includes enhanced concentrations of graphite as an infrared attenuation agent to achieve an XPS foam having an improved thermal insulation performance, while still maintaining a low content of open cells in the XPS foam.

### RELATED APPLICATIONS

This application claims priority to and all benefit of U.S. Provisional Patent Application Ser. No. 62/167,949, filed on May 29, 2015, for EXTRUDED POLYSTYRENE FOAM, the entire disclosure of which is fully incorporated herein by reference.

### FIELD

The present disclosure relates to a composition for and method of making extruded polystyrene (XPS) foam. Particularly, the present disclosure relates to the use of enhanced concentrations of graphite as an infrared attenuation agent to achieve an XPS foam having an improved thermal insulation performance, while still maintaining a low content of open cells in the XPS foam.

### BACKGROUND

It is known that the overall heat transfer in typical foam can be separated into three components: thermal conduction from gas (or blowing agent vapor), thermal conduction from polymer solids (including foam cell wall and strut), and thermal radiation across the foam. Schutz and Glicksman, J. Cellular Plastics, March-April, 114-121 (1984). In general, it is estimated that 65% of the thermal transfer is by thermal conduction through the gas phase, 25% by thermal radiation, and the remaining 10% by solid phase thermal conduction.

As an independent pathway of heat transfer, thermal radiation occupies about 25% of the total transferred energy in the form of infrared light. Thus, it is desirable to seek materials that can attenuate infrared light by absorption, reflection, or diffraction. An effective infrared attenuation agent (IAA) favors increased reflection and absorption and decreased transmission of heat radiation. Graphite has been shown to be an efficient IAA, and low levels of graphite may improve the R-value by as much as 15%.

### SUMMARY

Various exemplary embodiments of the present invention are directed to a composition for and method of making extruded polymeric foam. The composition for and method of making extruded polymeric foam disclosed herein use enhanced concentrations of graphite as an infrared attenuation agent, while still maintaining a low content of open cells in the XPS foam.

In accordance with some exemplary embodiments, a foamable polymeric mixture is disclosed. The foamable polymeric mixture includes a primary polymer composition, a blowing agent composition, and at least one infrared attenuating agent compounded in a carrier polymer composition.

In accordance with some exemplary embodiments, a method of manufacturing an extruded polymeric foam is disclosed. The method includes introducing a primary polymer composition into a screw extruder to form a polymeric melt, injecting a blowing agent composition into the polymeric melt to form a foamable polymeric material, and introducing at least one infrared attenuating agent into the polymeric melt, wherein the at least one infrared attenuating agent is compounded in a carrier polymer composition. The extruded polymeric foam exhibits an open cell content of less than 5%.

In accordance with some exemplary embodiments, an extruded polymeric foam is disclosed. The extruded polymeric foam comprises a foamable polymeric material. The foamable polymeric material comprises a primary polymer composition, a blowing agent composition, and a graphite infrared attenuating agent compounded in a carrier polymer composition. The extruded polymeric foam exhibits an open cell content of less than 5%.

### BRIEF DESCRIPTION OF THE DRAWINGS

Various advantages of this invention will be apparent upon consideration of the following detailed disclosure of the invention, especially when taken in conjunction with the accompanying drawings wherein:

FIG. 1 is a schematic drawing of an exemplary extrusion apparatus useful for practicing methods according to the invention.

FIG. 2 shows the dispersion of graphite in styrene-acrylonitrile copolymer (SAN), in accordance with an exemplary embodiment of the present invention.

FIG. 3 shows the spread of graphite in polystyrene, in accordance with conventional processing methods.

FIG. 4A, FIG. 4B, FIG. 4C, AND FIG. 4D show Tunneling Electron Microscopy (TEM) scans of graphite dispersed in various polymer matrices. FIGS. 4A and 4C show graphite dispersed directly in polystyrene, in accordance with conventional processing methods. FIGS. 4B and 4D show the dispersion of graphite first masterbatched in SAN, in accordance with an exemplary embodiment of the present invention.

### DETAILED DESCRIPTION OF THE DISCLOSURE

A composition for and method of making extruded polymeric foam is described in detail herein. The method includes the use of enhanced concentrations of graphite as an infrared attenuation agent, while still maintaining a low content of open cells in the XPS foam. In some exemplary embodiments, the graphite is compounded in a carrier polymer. Because the carrier polymer is not compatible with the primary polystyrene polymer, two separate phase domains are formed. Thus, the graphite is substantially contained within the carrier polymer domain, which reduces the open cell content in the primary polystyrene domain due to a lack of cell wall penetration by the graphite particles. These and other features of the extruded polymeric foam, as well as some of the many optional variations and additions, are described in detail hereafter.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated herein by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “composition” and “inventive composition” may be used interchangeably herein.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

As used herein, unless specified otherwise, the values of the constituents or components are expressed in weight percent or % by weight of each ingredient in the composition. The values provided include up to and including the endpoints given.

As it pertains to the present disclosure, “closed cell” refers to a polymeric foam having cells, at least 95% of which are closed.

The general inventive concepts relate to a composition for and method of making an extruded foam including the use of enhanced concentrations of graphite as an infrared attenuation agent, while still maintaining a low content of open cells in the foam. In some exemplary embodiments, the foam is an extruded polystyrene (XPS) foam. In some exemplary embodiments, the graphite is compounded in a carrier polymer. As discussed in detail hereafter, the graphite is substantially contained within the carrier polymer domain, which reduces the open cell content in the primary polymeric domain due to a lack of cell wall penetration by the graphite particles.

In some exemplary embodiments, the graphite composition disclosed herein is in a solid state, and is compounded in a resin to form a “master batch” before being introduced into the polymer composition. The graphite may be compounded in a twin-screw extrusion process. In some exemplary embodiments, graphite powder and polymeric resin pellets are metered into an extruder hopper at a particular designed ratio. The resin is then melted in the extruder, and fully mixed with the graphite powder via the shearing forces among the screws and barrel of the extruder. The mixture flows through a spaghetti die, and the strings formed therein are then cooled in a water bath and cut into pellets by a pelletizer. These pellets constitute the “graphite masterbatch.”

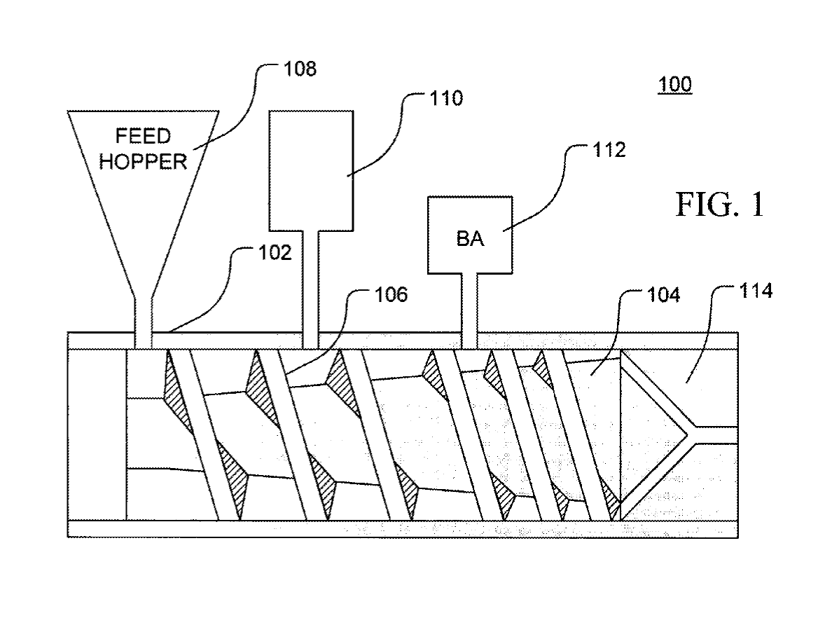

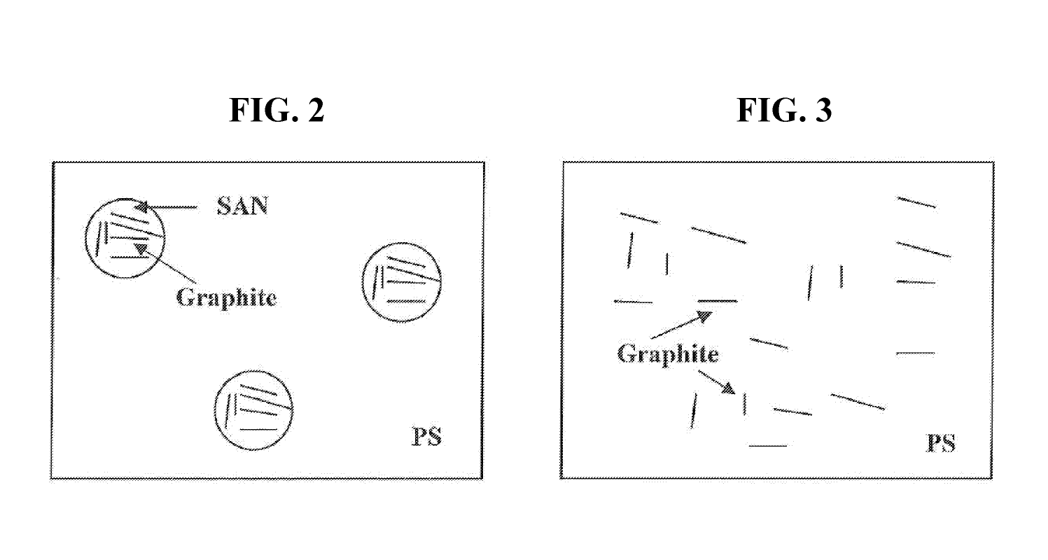

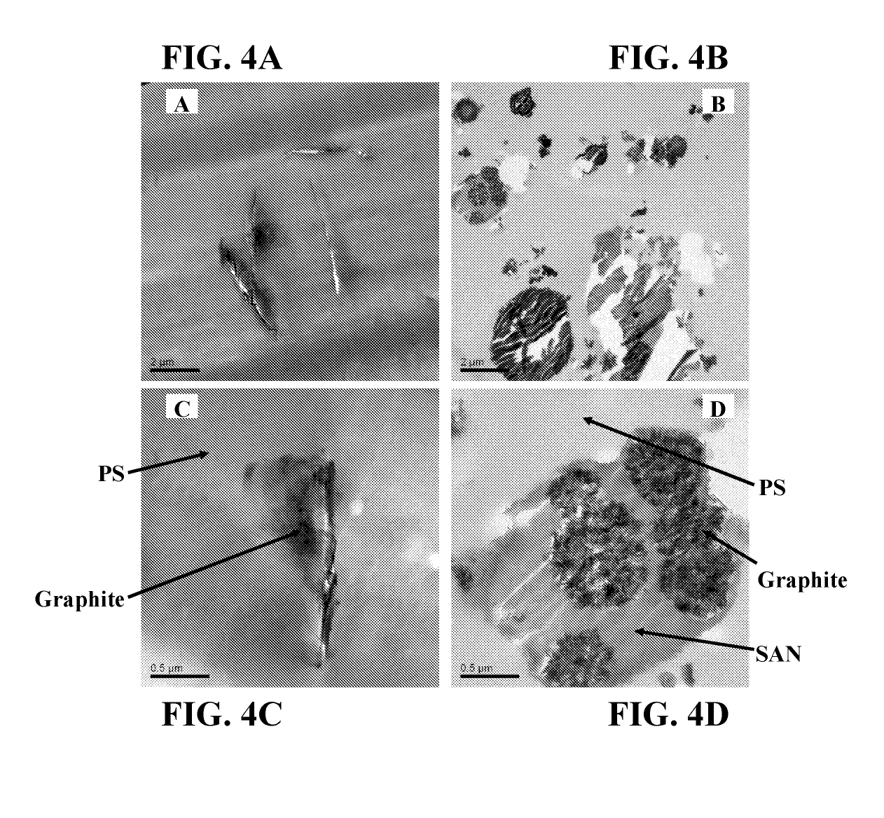

FIG. 1 illustrates a traditional extrusion apparatus 100 useful for practicing some exemplary embodiments of the present invention. The extrusion apparatus 100 may comprise a single or twin (not shown) screw extruder including a barrel 102 surrounding a screw 104 on which a spiral flight 106 is provided, configured to compress, and thereby, heat material introduced into the screw extruder. As illustrated in FIG. 1, the polymer composition may be fed into the screw extruder as a flowable solid, such as beads, granules or pellets, or as a liquid or semi-liquid melt, from one or more feed hoppers 108.

As the basic polymer composition advances through the screw extruder 100, the decreasing spacing of the flight 106 defines a successively smaller space through which the polymer composition is forced by the rotation of the screw. This decreasing volume acts to increase the pressure of the polymer composition to obtain a polymeric melt (if solid starting material was used) and/or to increase the pressure of the polymeric melt.

As the polymer composition advances through the screw extruder 100, one or more ports may be provided through the barrel 102 with associated apparatus 110 configured for injecting one or more infrared attenuating agents and/or one or more optional processing aids into the polymer composition. Similarly, one or more ports may be provided through the barrel 102 with associated apparatus 112 configured for injecting one or more blowing agents into the polymer composition. The graphite master batch is then added from a feeder, and introduced into the polymer composition via a hopper. In some exemplary embodiments, one or more optional processing aids and blowing agents are present in a super critical liquid state, and are injected into the extruder via a separate port by a pump. Once the graphite composition and/or one or more optional processing aids and blowing agent(s) have been introduced into the polymer composition, the resulting mixture is subjected to additional blending sufficient to distribute each of the additives generally uniformly throughout the polymer composition to obtain an extrusion composition.

This extrusion composition is then forced through an extrusion die 114 and exits the die into a region of reduced pressure (which may be below atmospheric pressure), thereby allowing the blowing agent to expand and produce a polymeric foam material. This pressure reduction may be obtained gradually as the extruded polymeric mixture advances through successively larger openings provided in the die or through some suitable apparatus (not shown) provided downstream of the extrusion die for controlling to some degree the manner in which the pressure applied to the polymeric mixture is reduced. The polymeric foam material may be subjected to additional processing such as calendaring, water immersion, cooling sprays, or other operations to control the thickness and other properties of the resulting polymeric foam product.

The foamable polymer composition is the backbone of the formulation and provides strength, flexibility, toughness, and durability to the final product. The foamable polymer composition is not particularly limited, and generally, any polymer capable of being foamed may be used as the foamable polymer in the resin mixture. The foamable polymer composition may be thermoplastic or thermoset. The particular polymer composition may be selected to provide sufficient mechanical strength and/or for use in the process to form a desired foamed polymer product. In addition, the foamable polymer composition is preferably chemically stable, that is, generally non-reactive, within the expected temperature range during formation and subsequent use in a polymeric foam.

As used herein, the terms “polymer” and “polymeric” are generic to the terms “homopolymer,” “copolymer,” “terpolymer,” and combinations of homopolymers, copolymers, and/or terpolymers. In one exemplary embodiment, the foamable polymer composition is an alkenyl aromatic polymer material. Suitable alkenyl aromatic polymer materials include alkenyl aromatic homopolymers and copolymers of alkenyl aromatic compounds and copolymerizable ethylenically unsaturated co-monomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer.

Examples of alkenyl aromatic polymers include, but are not limited to, those alkenyl aromatic polymers derived from alkenyl aromatic compounds such as styrene, alpha-methylstyrene, ethylstyrene, vinyl benzene, vinyl toluene, chlorostyrene, and bromostyrene. In at least one exemplary embodiment, the alkenyl aromatic polymer is polystyrene.

In certain exemplary embodiments, minor amounts of monoethylenically unsaturated monomers such as C2 to C6 alkyl acids and esters, ionomeric derivatives, and C2 to C6 dienes may be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate, and butadiene.

In certain exemplary embodiments, the foamable polymer melts may be formed substantially of (e.g., greater than 95 percent), and in certain exemplary embodiments, formed entirely of, polystyrene. The foamable polymer may be present in the polymeric foam in an amount from about 60% to about 99% by weight, in an amount from about 70% to about 99% by weight, or in an amount from about 85% to about 99% by weight. In certain exemplary embodiments, the foamable polymer may be present in an amount from about 90% to about 99% by weight. As used herein, the terms “% by weight” and “wt %” are used interchangeably and are meant to indicate a percentage based on 100% of the total weight of all ingredients excluding the blowing agent composition.

Exemplary embodiments of the subject invention utilize a blowing agent composition. Any suitable blowing agent may be used in accordance with the present invention. In some exemplary embodiments, carbon dioxide comprises the sole blowing agent. However, in other exemplary embodiments, blowing agent compositions that do not include carbon dioxide may be used. In some exemplary embodiments, the blowing agent composition comprises carbon dioxide, along with one or more of a variety of co-blowing agents to achieve the desired polymeric foam properties in the final product.

According to one aspect of the present invention, the blowing agent or co-blowing agents are selected based on the considerations of low global warming potential (GWP), low thermal conductivity, non-flammability, high solubility in polystyrene, high blowing power, low cost, and/or the overall safety of the blowing agent composition. In some exemplary embodiments, the blowing agent or co-blowing agents of the blowing agent composition may comprise one or more halogenated blowing agents, such as hydrofluorocarbons (HFCs), hydrochlorofluorocarbons, hydrofluoroethers, hydrofluoroolefins (HFOs), hydrochlorofluoroolefins (HCFOs), hydrobromofluoroolefins, hydrofluoroketones, hydrochloroolefins, fluoroiodocarbons, alkyl esters such as methyl formate, water, alcohols such as ethanol, acetone, carbon dioxide (CO₂), and mixtures thereof. In other exemplary embodiments, the blowing agent or co-blowing agents comprise one or more HFOs, HFCs, and mixtures thereof.

The hydrofluoroolefin blowing agent or co-blowing agents agents may include, for example, 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); (cis and/or trans)-1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO-1216); 2-fluoropropene, 1-fluoropropene; 1,1-difluoropropene; 3,3-difluoropropene; 4,4,4-trifluoro-1-butene; 2,4,4,4-tetrafluorobutene-1; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO-1336mzz-Z (cis) or HFO-1336mzz-E (trans)); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-I-butene; 3,3-difluoro-I-butene; 3,4,4-trifluoro-I-butene; 2,3,3-trifluoro-1-butene; I, 1,3,3-tetrafluoro-I-butene; 1,4,4,4-tetrafluoro-1-butene; 3,3,4,4-tetrafluoro-1-butene; 4,4-difluoro-1-butene; I, I, 1-trifluoro-2-butene; 2,4,4,4-tetrafluoro-1-butene; 1,1,1,2-tetrafluoro-2butene; 1,1,4,4,4-pentafluorol-butene; 2,3,3,4,4-pentafluoro-1-butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. In some exemplary embodiments, the blowing agent or co-blowing agents include HFO-1234ze.

The blowing agent or co-blowing agents may also include one or more hydrochlorofluoroolefins (HCFO), hydrochlorofluorocarbons (HCFCs), or hydrofluorocarbons (HFCs), such as HCFO-1233; 1-chloro-1,2,2,2-tetrafluoroethane (HCFC-124); 1,1-dichloro-1-fluoroethane (HCFC-141b); 1,1,1,2-tetrafluoroethane (HFC-134a); 1,1,2,2-tetrafluoroethane (HFC-134); 1-chloro 1,1-difluoroethane (HCFC-142b); 1,1,1,3,3-pentafluorobutane (HFC-365mfc); 1,1,1,2,3,3,3-heptafluoropropane (HFC-227ea); tnchlorofluoromethane (CFC-11); dichlorodifluoromethane (CFC-12); dichlorofluoromethane (HCFC-22), 1,2-difluoroethane (HFC-152), and 1,1-difluoroethane (HFC-152a).

The term “HCFO-1233” is used herein to refer to all trifluoromonochloropropenes. Among the trifluoromonochloropropenes are included both cis- and trans-1,1,1-trifluo-3,chlororopropene (HCFO-1233zd or 1233zd). The term “HCFO-1233zd” or “1233zd” is used herein generically to refer to 1,1,1-trifluo-3,chloro-propene, independent of whether it is the cis- or trans-form. The terms “cis HCFO-1233zd” and “trans HCFO-1233zd” are used herein to describe the cis- and trans-forms of 1,1,1-trifluo,3-chlororopropene, respectively. The term “HCFO-1233zd” therefore includes within its scope cis HCFO-1233zd (also referred to as 1233zd(Z)), trans HCFO-1233zd (also referred to as 1233(E)), and all combinations and mixtures of these.

In some exemplary embodiments, the blowing agent or co-blowing agents may comprise one or more hydrofluorocarbons. The specific hydrofluorocarbon utilized is not particularly limited. A non-exhaustive list of suitable HFC blowing agents or co-blowing agents include 1,1-difluoroethane (HFC-152a), 1,1,1,2-tetrafluoroethane (HFC-134a), 1,1,2,2-tetrafluoroethane (HFC-134), 1,1,1-trifluoroethane (HFC-143a), difluoromethane (HFC-32), pentafluoro-ethane (HFC-125), fluoroethane (HFC-161), 1,1,2,2,3,3-hexafluoropropane (HFC 236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-245ca), 1,1,2,3,3-pentafluoropropane (HFC-245ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof.

In some exemplary embodiments, the blowing agent or co-blowing agents are selected from hydrofluoroolefins, hydrofluorocarbons, and mixtures thereof. In some exemplary embodiments, the blowing agent composition comprises carbon dioxide and the co-blowing agent HFC-152a or HFC-134a. In some exemplary embodiments, the blowing agent composition comprises carbon dioxide and HFO-1234ze. The co-blowing agents identified herein may be used singly or in combination.

In some exemplary embodiments, the total blowing agent composition is present in an amount from about 1% to about 15% by weight, and in other exemplary embodiments, from about 3% to about 12% by weight, or from about 5% to about 11% by weight (based upon the total weight of all ingredients excluding the blowing agent composition).

The blowing agent composition may be introduced in liquid or gaseous form (e.g., a physical blowing agent) or may be generated in situ while producing the foam (e.g., a chemical blowing agent). For instance, the blowing agent may be formed by decomposition of another constituent during production of the foamed thermoplastic. For example, a carbonate composition, polycarbonic acid, sodium bicarbonate, or azodicarbonamide and others that decompose and/or degrade to form N₂, CO₂, and H₂O upon heating may be added to the foamable resin and carbon dioxide will be generated upon heating during the extrusion process.

The foamable composition disclosed herein contains at least one infrared attenuation agent (IAA) composition to increase the R-value of the resulting foam product. The use of infrared attenuating agents is disclosed in U.S. Pat. No. 7,605,188, which is incorporated herein by reference in its entirety. In some exemplary embodiments, the infrared attenuating agent may be present in an amount from 0% to about 10% by weight, from about 0.5% to about 5% by weight, from about 0.5% to about 3% by weight, or from about 0.8% to about 2% by weight (based upon the total weight of all ingredients excluding the blowing agent composition). The amounts of the blowing agent composition and infrared attenuation agent disclosed herein differ from conventional embodiments, in which a blowing agent is typically utilized in an amount greater than 7%, together with a small amount (i.e., less than 0.5%) of a graphite IAA, in order to achieve an R-value of approximately 5.

In accordance with the present disclosure, the at least one IAA composition comprises graphite. In some exemplary embodiments, the graphite is nano-graphite. In some exemplary embodiments, the graphite is compounded in a carrier polymer. In some exemplary embodiments, the carrier polymer is selected from styrene-acrylonitrile copolymer (SAN), poly(methyl methacrylate) (PMMA), polyethylene methacrylate (PEMA), polypropylene methacrylate (PPMA) and other homolog's, and styrene-methyl methacrylate copolymer. However, the carrier polymer is not limited to these disclosed embodiments, and may include any carrier polymer capable of containing the graphite in the carrier phase. In some exemplary embodiments, the carrier polymer may be any polymer resin that is not compatible with a polystyrene matrix. Moreover, the graphite may be compounded in a carrier resin that is a polymer, a plastic, or an elastomer.

As shown in FIG. 2, because the carrier polymer is not compatible with the primary polystyrene polymer (PS), two separate phase domains are formed. This is different from conventional procedures, wherein graphite is dispersed directly in the polystyrene, as shown in FIG. 3.

The Tunneling Electron Microscopy (TEM) images shown in FIGS. 4A through 4D further illustrate the phase separation achieved by compounding the graphite in a carrier polymer in accordance with the present invention. FIGS. 4A and 4C show graphite dispersed directly in polystyrene, in accordance with conventional processing methods. FIGS. 4B and 4D show the dispersion of graphite first masterbatched in the exemplary carrier, styrene-acrylonitrile copolymer (SAN).

FIGS. 4A through 4D show the incompatibility and separate phases formed by polystyrene and SAN. By compounding the graphite in the SAN carrier polymer, the graphite remains substantially contained within the carrier polymer domain, which reduces the open cell content in the primary polystyrene domain due to a lack of cell wall penetration by the graphite particles. This is particularly desirable, as a high open cell content has an adverse effect on the R-value and compressive strength of XPS foam.

The foam composition may further contain a fire retarding agent in an amount up to 5% or more by weight (based upon the total weight of all ingredients excluding the blowing agent composition). For example, fire retardant chemicals may be added in the extruded foam manufacturing process to impart fire retardant characteristics to the extruded foam products. Non-limiting examples of suitable fire retardant chemicals for use in the inventive composition include brominated aliphatic compounds such as hexabromocyclododecane (HBCD) and pentabromocyclohexane, brominated phenyl ethers, esters of tetrabromophthalic acid, halogenated polymeric flame retardant such as brominated polymeric flame retardant based on styrene butadiene copolymers, phosphoric compounds, and combinations thereof.

Optional additives such as nucleating agents, plasticizing agents, pigments, elastomers, extrusion aids, antioxidants, fillers, antistatic agents, biocides, termite-ocide, colorants, oils, waxes, flame retardant synergists, and/or UV absorbers may be incorporated into the inventive composition. These optional additives may be included in amounts necessary to obtain desired characteristics of the foamable gel or resultant extruded foam products. The additives may be added to the polymeric mixture or they may be incorporated in the polymeric mixture before, during, or after the polymerization process used to make the polymer.

Once the polymer processing aid(s), blowing agent(s), IAA(s), and optional additional additives have been introduced into the polymeric material, the resulting mixture is subjected to some additional blending sufficient to distribute each of the additives generally uniformly throughout the polymer composition to obtain an extrusion composition.

In some exemplary embodiments, the foam composition produces rigid, substantially closed cell, polymer foam boards prepared by an extruding process. Extruded foams have a cellular structure with cells defined by cell membranes and struts. Struts are formed at the intersection of the cell membranes, with the cell membranes covering interconnecting cellular windows between the struts. In some exemplary embodiments, the foams have an average density of less than 10 pcf, or less than 5 pcf, or less than 3 pcf. In some exemplary embodiments, the extruded polystyrene foam has a density from about 1.3 pcf to about 4.5 pcf. In some exemplary embodiments, the extruded polystyrene foam has a density from about 1.4 pcf to about 3 pcf. In some exemplary embodiments, the extruded polystyrene foam has a density of about 2 pcf. In some exemplary embodiments, the extruded polystyrene foam has a density of about 1.5 pcf, or lower than 1.5 pcf.

It is to be appreciated that the phrase “substantially closed cell” is meant to indicate that the foam contains all closed cells or nearly all of the cells in the cellular structure are closed. In most exemplary embodiments, not more than 5% of the cells are open cells, or otherwise “non-closed” cells. In some exemplary embodiments, from 0% to about 5% of the cells are open cells. In some exemplary embodiments, from about 3% to about 4% of the cells are open cells. The closed cell structure helps to increase the R-value of a formed foamed insulation product.

Additionally, the inventive foam composition produces extruded foams that have insulation values (R-values) per inch of at least 4, or from about 4 to about 7. In addition, the average cell size of the inventive foam and foamed products may be from about 0.05 mm (50 microns) to about 0.4 mm (400 microns), in some exemplary embodiments from about 0.1 mm (100 microns) to about 0.3 mm (300 microns), and in some exemplary embodiments from about 0.11 mm (110 microns) to about 0.25 mm (250 microns). The extruded inventive foam may be formed into an insulation product such as a rigid insulation board, insulation foam, packaging product, and building insulation or underground insulation (for example, highway, airport runway, railway, and underground utility insulation).

The inventive foamable composition additionally may produce extruded foams that have a high compressive strength, which defines the capacity of a foam material to withstand axially directed pushing forces. In at least one exemplary embodiment, the inventive foam compositions have a compressive strength within the desired range for extruded foams, which is between about 6 psi and about 120 psi. In some exemplary embodiments, the inventive foamable composition produces foam having a compressive strength between about 10 and about 110 psi after 30 days aging.

In accordance with another exemplary aspect, the extruded inventive foams possess a high level of dimensional stability. For example, the change in dimension in any direction is 5% or less. In addition, the foam formed by the inventive composition is desirably monomodal and the cells have a relatively uniform average cell size. As used herein, the average cell size is an average of the cell sizes as determined in the X, Y, and Z directions. In particular, the “X” direction is the direction of extrusion, the “Y” direction is the cross machine direction, and the “Z” direction is the thickness direction. In the present invention, the highest impact in cell enlargement is in the X and Y directions, which is desirable from an orientation and R-value perspective. In addition, further process modifications would permit increasing the Z-orientation to improve mechanical properties while still achieving an acceptable thermal property. The extruded inventive foam can be used to make insulation products such as rigid insulation boards, insulation foam, and packaging products.

As previously disclosed in detail herein, the polymeric foam of the present invention includes the use of increased concentrations of graphite as an infrared attenuation agent, while still maintaining a low content of open cells in the extruded foam. The graphite is substantially contained within a carrier polymer domain, which reduces the open cell content in the primary polystyrene domain. This reduction is due to a lack of cell wall penetration by the graphite particles—because the graphite particles are maintained in the carrier polymer domain, they are prevented from penetrating the cell walls and causing cell rupture.

The inventive concepts have been described above both generically and with regard to various exemplary embodiments. Although the general inventive concepts have been set forth in what is believed to be exemplary illustrative embodiments, a wide variety of alternatives known to those of skill in the art can be selected within the generic disclosure. Additionally, the following examples are meant to better illustrate the present invention, but are in no way intended to limit the general inventive concepts of the present invention.

### EXAMPLES

A variety of extruded polystyrene (“XPS”) foams were prepared using a twin screw extruder. First, 20 wt. % of graphite was compounded in SAN (Lustran SAN Sparkle Lub 552190 from Ineos ABS) as a graphite/SAN masterbatch. Thereafter, polystyrene, the graphite/SAN masterbatch, and other solid raw materials were melted in the extruder and then injected with a blowing agent composition to form homogeneous solutions. The solutions were then cooled to the desired foaming conditions. In some exemplary embodiments, the foaming die temperature was between 110° C. and 130° C., and the foaming die pressure was between 800 psi and 1200 psi. Foam boards were produced having a thickness of 1 inch and a width of 20 inches for the exemplary embodiments evaluated herein.

### Examples 1 and 2

The exemplary XPS foams of Examples 1 and 2 were prepared with varying concentrations of graphite/SAN masterbatch, together with carbon dioxide as the exclusive blowing agent. Tables 1 and 2 below show the exemplary effects of the graphite/SAN masterbatch. In Table 1, XPS foams were prepared via conventional methods of dispersing graphite directly in polystyrene. In Table 2, XPS foams were prepared in accordance with the invention disclosed herein, with the graphite first dispersed in SAN.

As shown in Table 2, a graphite concentration as high as 1.6 wt. % prepared by first dispersing the graphite in SAN achieved an XPS foam having an open cell content as low as 3.8%. In comparison, as shown in Table 1, an XPS foam prepared using an identical amount of graphite without first dispersing it in SAN resulted in an open cell content of 85.7%.

TABLE 1
Open cell content of XPS foam prepared by dispersing
graphite directly in polystyrene

| | Graphite | Foam Density | Foam Cell | Open Cell | |
|---|---|---|---|---|---|
| Sample | (wt. %) | (pcf) | Size (mm) | Content (%) | R/in |
| 1 | 0.8 | 3.7 | 0.15 | 44.8 | 4.5 |
| 2 | 0.8 | 2.0 | 0.16 | 52.4 | 4.6 |
| 3 | 1.6 | 3.0 | 0.15 | 85.7 | 4.7 |

TABLE 2
Open cell content of XPS foam prepared by first
dispersing graphite in SAN

| | Graphite | Foam Density | Foam Cell | Open Cell | |
|---|---|---|---|---|---|
| Sample | (wt. %) | (pcf) | Size (mm) | Content (%) | R/in |
| 4 | 0.8 | 2.6 | 0.10 | 4.3 | 4.6 |
| 5 | 0.8 | 1.9 | 0.11 | 3.9 | 4.6 |
| 6 | 1.6 | 2.5 | 0.10 | 3.8 | 4.6 |

### Example 3

The exemplary XPS foam of Example 3 was prepared using a graphite/SAN masterbatch, together with a CO₂ and HFC-134a blowing agent. As shown in Table 3, a graphite concentration as high as 1 wt. % prepared by first dispersing the graphite in SAN achieved an XPS foam having an R-value of 5/inch, while using only 3.0 wt. % HFC-134a.

TABLE 3
XPS foam prepared using graphite dispersed in SAN together with a CO₂/HFC-134a
Blowing Agent

| | | | | R/in at | Cell | | Compressive | Compressive |
|---|---|---|---|---|---|---|---|---|
| CO₂ | HFC- | Graphite | Density | 180 | size | Open | strength | modulus |
| (%) | 134a (%) | (%) | (pcf) | days | (mm) | cell (%) | (psi) | (psi) |
| 2.2 | 3.0 | 1.0 | 2.1 | 5 | 0.10 | 2.85 | 38.0 | 1120.6 |

In contrast, an XPS foam prepared without the graphite required a higher amount (5.5%) of HFC-134a to achieve an R-value of 5/inch at an equivalent density.

### Example 4

The exemplary XPS foam of Example 4 was prepared using a graphite/SAN masterbatch, together with a CO₂ and HFO-1234ze blowing agent. As shown in Table 4, a graphite concentration as high as 1 wt. % prepared by first dispersing the graphite in SAN achieved an XPS foam having an R-value of 5/inch, while using only 3.5 wt. % HFO-1234ze. In contrast, an XPS foam prepared without the graphite required 6% or higher HFO-1234ze to achieve an R-value of 5/inch at an equivalent density.

TABLE 4
XPS foam prepared using graphite dispersed in SAN together with a CO₂/HFO-1234ze
Blowing Agent

| | HFO- | | | | Cell | Open | Compressive | |
|---|---|---|---|---|---|---|---|---|
| CO₂ | 1234ze | Graphite | Density | R/in at | size | cell | strength | Compressive |
| (%) | (%) | (%) | (pcf) | 180 days | (mm) | (%) | (psi) | modulus (psi) |
| 2.2 | 3.5 | 1.0 | 2.1 | 5 | 0.10 | 1.57 | 51.3 | 1249.6 |

Thus, the methods disclosed herein provide for an XPS foam having a high concentration of graphite, while minimizing the open cell content of the foam. This allows for the use of low thermal conductivity blowing agents together with high concentrations of graphite to obtain a desired thermal insulation R-value.

As used in the description of the invention and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B), it is intended to mean “A or B or both.” When the applicants intend to indicate “only A or B but not both,” then the term “only A or B but not both” will be employed. Thus, use of the term “or” herein is the inclusive, and not the exclusive, use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the Applicant to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the Applicant's general disclosure herein.

What is claimed is:

1. A foamable polymeric mixture comprising:
a primary polymer composition;
a blowing agent composition; and
at least one infrared attenuating agent compounded in a carrier polymer composition.

2. The foamable polymeric mixture of claim 1, wherein the at least one infrared attenuating agent comprises graphite.

3. The foamable polymeric mixture of claim 1, wherein the carrier polymer composition is selected from styrene-acrylonitrile copolymer (SAN), poly(methyl methacrylate) (PMMA), polyethylene methacrylate (PEMA), and styrene-methyl methacrylate copolymer.

4. The foamable polymeric mixture of claim 1, wherein the at least one infrared attenuating agent comprises from 0.5% to 5% by weight based upon the total weight of the mixture excluding the blowing agent composition.

5. The foamable polymeric mixture of claim 1, wherein the blowing agent composition comprises carbon dioxide.

6. The foamable polymeric mixture of claim 1, wherein the primary polymer composition comprises polystyrene.

7. A method of manufacturing an extruded polymeric foam, the method comprising:
introducing a primary polymer composition into a screw extruder to form a polymeric melt;
injecting a blowing agent composition into the polymeric melt to form a foamable polymeric material; and
introducing at least one infrared attenuating agent into the polymeric melt, wherein the at least one infrared attenuating agent is compounded in a carrier polymer composition,
wherein the extruded polymeric foam exhibits an open cell content of less than 5%.

8. The method of claim 7, wherein the at least one infrared attenuating agent comprises graphite.

9. The method of claim 7, wherein the carrier polymer composition is selected from styrene-acrylonitrile copolymer (SAN), poly(methyl methacrylate) (PMMA), polyethylene methacrylate (PEMA), and styrene-methyl methacrylate copolymer.

10. The method of claim 7, wherein the blowing agent composition comprises carbon dioxide.

11. The method of claim 7, wherein the at least one infrared attenuating agent comprises from 0.5% to 5% by weight based upon the total weight of the polymeric melt excluding the blowing agent composition.

12. The method of claim 7, wherein the primary polymer composition comprises polystyrene.

13. An extruded polymeric foam comprising:
a foamable polymeric material, the material comprising:
a primary polymer composition;
a blowing agent composition comprising carbon dioxide; and
a graphite infrared attenuating agent compounded in a carrier polymer composition,
wherein the extruded polymeric foam exhibits an open cell content of less than 5%.

14. The extruded polymeric foam of claim 13, wherein the carrier polymer composition is selected from styrene-acrylonitrile copolymer (SAN), poly(methyl methacrylate) (PMMA), polyethylene methacrylate (PEMA), and styrene-methyl methacrylate copolymer.

15. The extruded polymeric foam of claim 13, wherein the primary polymer composition comprises polystyrene.
